(19) United States
(12) Patent Application Publication
(10) Pub. No.: US 2026/0118241 A1
(43) Pub. Date: Apr. 30, 2026

(54) APPARATUS AND METHOD FOR HIGH VELOCITY EROSION

(71) Applicant: United Protective Technologies, LLC, Locust, NC (US)

(72) Inventors: Timothy Curtis Simmons, Jr., Charlotte, NC (US); Peter Schmidt, Harrisburg, NC (US); Robert Nichol, Hooksett, NH (US); Cantwell George Carson, Pittsburgh, PA (US)

(73) Assignee: United Protective Technologies, LLC, Locust, NC (US)

(21) Appl. No.: 18/823,582

(22) Filed: Sep. 3, 2024

Related U.S. Application Data
(60) Provisional application No. 63/536,310, filed on Sep. 1, 2023.

(51) Int. Cl. G01N 3/56; G01N 17/00

(52) U.S. Cl. CPC G01N 3/565; G01N 17/00

(57) ABSTRACT

Apparatuses, systems, and methods are described herein for high velocity erosion. The apparatus comprises a container, a propellant stored in the container, wherein the propellant is stored under pressure in the container, an applicator, the applicator being in fluid communication with the container, the applicator comprising a heater, and a controller for controlling the heater and the flow of propellant from the applicator, wherein the applicator is structured to discharge the propellant at a high velocity.

### CROSS-REFERENCES TO RELATED APPLICATIONS

This is a non-provisional patent application claiming priority to provisional patent application No. 63/536,310 filed Sep. 1, 2023, and titled “Apparatus and Method for High Velocity Erosion.”

### GOVERNMENT RIGHTS

This invention was made in part with government support under contract number FA864924P0500 awarded by the U.S. Air Force Research Laboratory. The government has certain rights in the invention.

### FIELD OF THE INVENTION

The present invention relates to an apparatus for high velocity erosion and a method of use.

### BACKGROUND OF THE INVENTION

Existing apparatuses and methods for testing materials at high velocity, particularly at supersonic and hypersonic speeds, pose significant challenges in accurately assessing properties such as abrasion, wear, and other factors. Furthermore, the existing test apparatuses used for such evaluations tend to be non-portable and large in size, preventing the ability to conduct tests in various locations and environments. Traditionally, these implementations rely on testing apparatuses that are limited by their inability to provide long-duration tests, as they are often restricted to very short lengths of time. Consequently, obtaining data regarding a tested material's behavior, performance, and wear characteristics under sustained high-velocity conditions is exceedingly difficult. Accordingly, there is a need for an apparatus and method for high velocity erosion.

### SUMMARY OF INVENTION

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, an apparatus for high velocity erosion is presented. The apparatus may include a container, a propellant stored in the container, wherein the propellant is stored under pressure in the container, an applicator, the applicator being in fluid communication with the container, the applicator including a heater, and a controller for controlling the heater and the flow of propellant from the applicator, wherein the applicator is structured to discharge the propellant at a high velocity.

In some embodiments, the applicator introduces media into the propellant.

In some embodiments, multiple media feeders may be used to tailor the erosive media stream characteristics. See U.S. Pat. No. 7,273,075 B2.

In some embodiments, the apparatus may further include an enclosure comprising a retainer.

In some embodiments, the enclosure may include an evacuation unit to collect media introduced by the applicator into the propellant.

In some embodiments, the applicator may include a mechanical manipulator.

In some embodiments, the test article may be moved past a fixed applicator.

In some embodiments, the applicator or specimen may be moved manually by the operator.

In some embodiments, the propellant is a gas when emitted from the applicator.

In some embodiments, the propellant includes nitrogen.

In some embodiments, the nitrogen, when stored under pressure in the container, is at least one selected from the group consisting of a liquid phase and a gaseous phase.

In some embodiments, the propellant includes helium.

In some embodiments, the helium, when stored under pressure in the container, is at least one selected from the group consisting of a liquid phase and a gaseous phase.

In another aspect, a method for high velocity erosion is presented. The method may include storing propellant in a container, discharging the propellant from the container to an applicator, heating the propellant, discharging the propellant from the applicator at a high velocity, and exposing the article to high-velocity flow for a predetermined time period. In one embodiment, the method further comprises, prior to the second discharging step, introducing media into the propellant. In another embodiment, the method further comprises collecting media in an evacuation unit. In another embodiment, the propellant comprises a fluid selected from the group consisting of nitrogen, hydrogen, carbon dioxide, helium, and oxygen, and mixtures thereof. In another embodiment, the fluid, when stored under pressure in the container, is at least one selected from the group consisting of a liquid phase and a gaseous phase. In yet another embodiment, the predetermined time period exceeds twenty minutes.

In yet another aspect, a system for high velocity erosion testing of an article is presented. The system may include an apparatus, the apparatus including a container, a propellant stored in the container, wherein the propellant is stored under pressure in the container, an applicator, the applicator being in fluid communication with the container, the applicator including a heater, and a controller for controlling the heater and the flow of propellant from the applicator, wherein the propellant is discharged from the applicator at a controlled speed, generating a high velocity flow, wherein the article is exposed to the high velocity flow for a predetermined time period.

In some embodiments, the system may be used without erosive particles to study ablative effects, for example, reentry and hypersonic vehicles operating outside of where erosive particles are present in the atmosphere.

### BRIEF DESCRIPTION OF THE SEVERAL VIEWS OF THE DRAWINGS

Having thus described embodiments of the invention in general terms, reference will now be made to the accompanying drawings, wherein:

FIG. 1 illustrates a perspective view of an apparatus for high velocity erosion, according to one embodiment of the present invention; and

FIG. 2 illustrates a partial cutaway view of an applicator, according to one embodiment of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

Additionally, certain terminology is used herein for convenience only and is not to be interpreted as a limitation on the embodiments described. For example, the words “top,” “bottom,” “upper,” “lower,” “left,” “right,” “horizontal,” “vertical,” “upward,” and “downward” merely describe the configurations as depicted in the figures. Indeed, the referenced components in the figures may be oriented in any direction, unless specified otherwise, the configurative terminology used herein should be understood as encompassing such variations.

As used herein, “high velocity” refers to controlled aerodynamic speed regimes including, without limitation, subsonic, transonic, hypersonic, and supersonic speeds.

It should also be understood that “operable communication” or “operably coupled” as used herein, means that the components may be formed integrally with each other, or may be formed separately and coupled together. Furthermore, “operable communication” means that the components may be formed directly to each other, or to each other with one or more components located between the components that are operatively coupled together. Furthermore, “operable communication” or “operable coupled” may mean that the components are detachable from each other, or that they are permanently coupled together. Furthermore, components in operable communication may mean that the components retain at least some freedom of movement in one or more directions or may be rotated about an axis (i.e., rotationally coupled, pivotally coupled). Furthermore, “operable communication” or “operably coupled” may mean that components may be electronically connected and/or in fluid communication with one another.

The technical features of the apparatus provide a novel approach to the testing of articles in high velocity flow, by allowing for testing to occur in a controlled environment suitable for monitoring of the high velocity flow, any media that may be introduced into the high velocity flow, and any erosion that occurs as a result.

Embodiments of the invention are directed to an apparatus for high velocity erosion and a method of use. The apparatus and method described herein allow for testing, in a controlled environment, the erosion that may occur as a result of exposing an article or material to high velocity flow including, without limitation, hypersonic flow. While hypersonic flow may occur during aircraft, spacecraft flight, and ballistics activities, collecting data regarding the wear characteristics of materials during these activities is time consuming, expensive, and may often be dangerous.

Importantly, the apparatus improves upon the traditional hypersonic testing devices by reducing the size of the overall apparatus, reducing the size of the container(s) required to hold the propellant, and increasing the duration of the testing (i.e., the length of time that an article is exposed to hypersonic flow) by storing the propellant as a liquid or gas. Unlike traditional hypersonic testing systems that are large and immobile, the reduced size of the overall apparatus presented herein is conducive to rapidly deploying and transporting the apparatus to various sites. Further, instead of relying on pressurized gas in a gaseous state to provide the requisite flow at high velocities, the present apparatus utilizes liquid or gas stored in containers as a propellant, which, as a result of heating and a divergent-convergent applicator, undergoes a volumetric expansion. This rapid increase in volume of the propellant, combined with the reduction in diameter of the nozzle, allows for the sustained release of hypersonic propellant (and any media contained therein) directed to the article for erosion testing.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

As will be appreciated by one of ordinary skill in the art in view of this disclosure, the present invention may include and/or be embodied as an apparatus (including, for example, a system, machine, device, computer program product, and/or the like), as a method (including, for example, a computer-implemented process, and/or the like), or as any combination of the foregoing. Accordingly, embodiments of the present invention may take the form of an entirely apparatus embodiment, an entirely software embodiment (including firmware, resident software, micro-code, stored procedures in a database, or the like), an entirely hardware embodiment, or an embodiment combining the apparatus, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “structured to” or “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized to store computer-executable program code for performing the method(s) described herein. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions (e.g., computer instructions) for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F #.

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s). The one or more computer-executable program code portions may also be loaded onto a computer, controller, and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

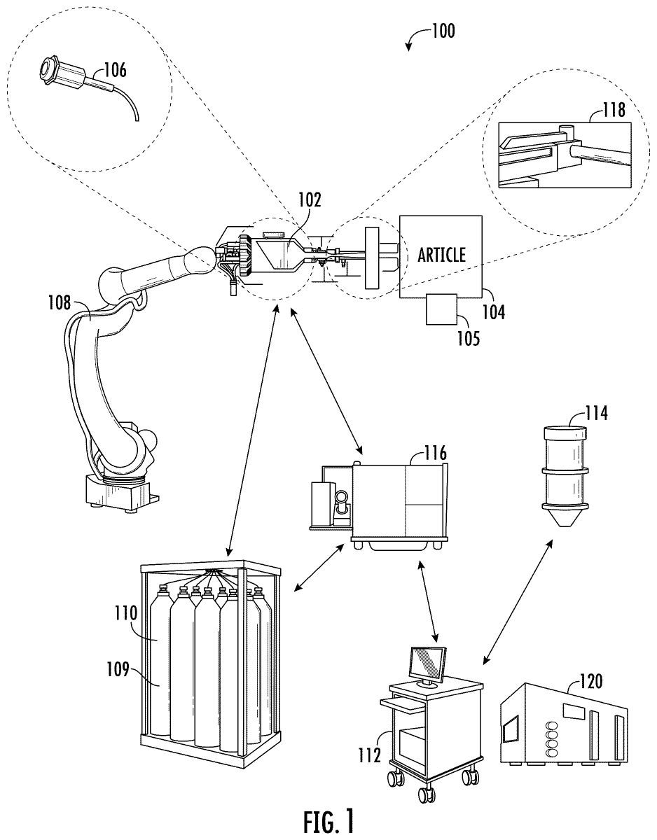

FIG. 1 illustrates a perspective view 100 of an apparatus for high velocity erosion, according to one embodiment of the present invention. An article 104 is placed proximate an applicator 102 for high velocity erosion testing. In some embodiments, the article 104 may be placed and secured in a retainer 105.

As used herein, “erosion” may refer to any process that involves the removal, degradation, or wearing away of material from surfaces due to the effects of high-speed airflow, high temperatures, chemical reactions, particulates, or other aerodynamic or mechanical forces. In some embodiments, the “erosion” testing measures the ablative effects of high-velocity gas without the introduction of erosive media.

As used herein, a “retainer” may refer to any device for fixing or otherwise retaining the test article 104, to ensure its stability and prevent unintended movement during application, including, but not limited to, clamps, spring clamps, vices, chucks, magnetic holders or any other device structured to receive the article 104 and maintain the position of the article 104 during testing.

The article 104 may be any part, assembly, sample, or material suitable for testing at high velocities, including, but not limited to, aerostructures, heat shields, propulsion systems, consisting of suitable metals, composites, plastics, ceramics, or other high-temperature materials, any of which may be coated with a protective coating prior to testing in the present apparatus. Accordingly, the testing may facilitate research related to hypersonic flow and understanding the behavior of materials under extreme aerodynamic forces and resulting heat conditions. In some embodiments, the article 104 may include sensors, instrumentation, or diagnostic equipment coupled to the article 104 such as to gather data and monitor various parameters during hypersonic testing.

In the apparatus described herein, the article 104 is subjected to a flow of propellant 109 at supersonic and hypersonic speeds. In some embodiments, the propellant 109 includes media that has been introduced to the propellant 109 at the applicator 102 in order to simulate the erosion of surfaces of the article 104 at high velocities as the article 104 comes into contact with various particulate matter. The flow of gas and the media are combined at the applicator 102, which is ultimately placed proximate the article 104 such that the flow of propellant 109 reaches the article 104.

In fluid communication with the applicator 102 may be a container 110, which may be comprised of a single container or multiple containers structured to hold a propellant 109 under pressure. The container 110 may be a high-pressure cylinder specifically designed to store liquified or compressed gas. The container 110 may feature a construction made of materials such as steel or aluminum, or other suitable solid materials that provide the necessary strength to withstand the internal pressure exerted by the liquified or compressed gas. The container 110 may also incorporate safety features such as pressure relief valves, and burst discs.

Importantly, it has been discovered that the longevity of erosion testing at high velocities can be significantly lengthened by supplying and storing propellant 109 as a liquid or compressed gas. Historically, containers 110 contained gas in a gaseous state that is supplied as a propellant 109 that is then subjected to an article 104. However, gas can only be safely compressed and stored at certain pressures, and as pressurized gas transitions from an elevated pressure to an ambient pressure, the resulting volumetric expansion only provides for gas flow directed at the article 104 for a short period of time before depleting the propellant 109 in the container 110.

The present apparatus implements a significant improvement to existing designs by storing the propellant 109 in a liquid or gaseous state in the container 110. In some embodiments, the propellant 109, when pressurized and stored in the container 110 may be a liquified gas including, but not limited to, liquid carbon dioxide, liquid helium, liquid nitrogen, liquid oxygen, liquid hydrogen, or various mixtures thereof.

In other embodiments, the propellant 109, when pressurized and stored in the container 110 may be a gas, including but not limited to gaseous carbon dioxide, gaseous helium, gaseous nitrogen, gaseous oxygen, gaseous hydrogen, air, or various mixtures thereof.

The propellant 109 is supplied to an applicator 102. In some embodiments, after being exposed to a heater 106, the propellant 109 undergoes a phase change from a liquid gas to a gas propellant 109. This phase change provides a significant increase in the volume of the propellant 109, and subsequent pressure of the propellant 109 within the applicator 102.

In other embodiments where the propellant 109 is a gas when pressurized in the container 110, the exposing of the propellant 109 to the heater 106 similarly increases the volume of the propellant 109 without undergoing a phase change. This increase in volume translates to a sustained flow of the propellant 109 at a given velocity once leaving the applicator 102, thus allowing for the continued operation of erosion testing for longer periods of time while maintaining a reasonable sized container 100.

In one embodiment, parameters such as the container 110 size, the propellant 109 type, the pressure of the propellant 109 in the container 11, and the applicator 102 nozzle diameter, are selected for erosion testing of up to 15 seconds. In another embodiment, the container 110 size, the propellant 109 type, the pressure of the propellant 109 in the container 11, and the applicator 102 nozzle diameter, are selected for erosion testing of durations up to or exceeding 30 seconds, 1 minute, 2 minutes, 3 minutes, 4 minutes, 5 minutes, 10 minutes, 15 minutes, 20 minutes, 30 minutes, 45 minutes, or 60 minutes.

Moreover, when compared to conventional erosion testing devices, the increase in the available volume of propellant 109 of the present apparatus at ambient pressures may also allow for the application of the propellant to the article 104 over larger surface areas at hypersonic and supersonic velocities while still maintaining an acceptably long duration of testing.

The applicator 102 and the container 110 may be in fluid communication via one or more hoses, conduit, or other fluid or gas transfer means. As a result of being in fluid communication with the container 110, the applicator 102 discharges the propellant 109 from the container 110 and directs it towards the article 104. In some embodiments, the applicator 102 and container 110 may be connected by a flexible hose that allows the transfer of fluid or gas therebetween. Alternatively, a rigid or semi-rigid conduit or any other suitable fluid conduit may be utilized to establish fluid communication. Various fittings, adapters, or quick-connect mechanisms can be employed to ensure a secure and leak-proof connection between the applicator 102 and the container 110.

The applicator 102 may be coupled to a controller 116, which manages the flow of the propellant 109 from the container 110 in a controlled manner. The primary function of the controller 116 is to regulate the release of the propellant 109 and control the heater 106, ensuring flow of the propellant 109 at a predetermined rate throughout the application process. In addition to propellant 109 flow control, the controller 116 may also govern the introduction of media into the flow of the propellant 109. The controller 116 incorporates mechanisms that allow for the controlled introduction of the particulate matter, ensuring it is evenly dispersed and integrated into the propellant flow.

The controller 116 may include various components, including sensors, valves, actuators, and electronic controls. The sensors monitor and provide feedback on parameters such as flow rate, pressure, and temperature, allowing the control unit to make necessary adjustments for precise control. Valves are employed to regulate the propellant flow and media introduction, while actuators enable the control unit to execute the desired actions based on input from the electronic controls. In some embodiments, the velocity of the flow rate of the propellant 109 may be predetermined by an operator of the apparatus prior to its operation. As will be described in detail hereinafter, the controller 116 may also control the heater 106 by increasing or decreasing the electrical power provided to the heater 106, which in turn changes the temperature of the propellant 109 in contact with the heater 106.

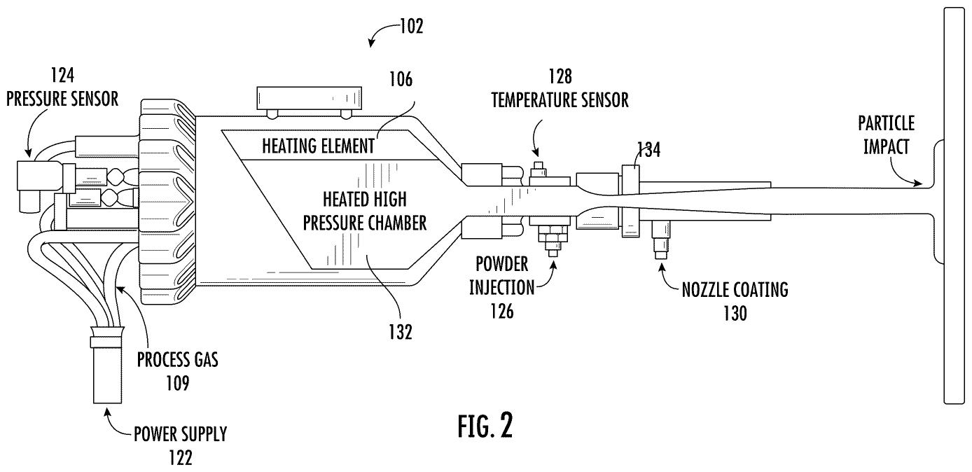

FIG. 2 illustrates a partial cutaway view of an applicator 102, according to one embodiment of the present invention. The applicator 102 may be supplied electrical power and signals through a power supply 122 from the controller 116, such as to operate various valves to open and close the applicator 102 to discharge the propellant at a high velocity, and to power the heater 106.

An electrical signal is sent from the controller 116 to the valves in the flow control system 116, where one or more valves are opened to allow the propellant 109 to enter into the void 132 of the applicator 102. A pressure sensor 124 may be operatively coupled to the applicator 102 such that the controller 116 receives information regarding the pressure of the propellant 109 in the void 132. In some embodiments, a predetermined pressure threshold between 0 psi and 10,000 psi is set at the controller by the user. Upon the pressure inside the void 132 reaching or rising above the predetermined threshold, one or more valves may be closed or partially closed to reduce or eliminate the entering of the propellant 109 into the void 132. Similarly, upon the pressure inside the void 132 being below the predetermined threshold, one or more valves may be opened or partially opened to increase the entering of the propellant 109 into the void 132 and thereby increase the pressure in the void 132.

In embodiments where the heater 106 is placed at the applicator 102, the heater 106 may be coupled to the void 132 within the applicator 102, where the void 132 receives the propellant 109 and subsequently is subjected to the heat emitted by the heater 106 through convection, conduction, or radiation heating. This heater 106 raises the temperature of the propellant 109 within the void 132 to ensure that the propellant 109 reaches its desired state (such as a pressure) for optimal performance. The elevated temperature provided by the heater 106 promotes expansion of the propellant 109, enabling it to be readily dispersed as intended.

Additionally, or alternatively, heater 106 may be a system designed to facilitate precise laser treatments and measurements. In some embodiments, the system may include a pyrometer, such as an optical pyrometer, infrared radiation pyrometer (including single-wavelength, ratio, and fiber optic infrared pyrometers), a total radiation pyrometer, and so forth. In one particular embodiment, the pyrometer may be a ratio pyrometer structured to determine the temperature of the article 104 by measuring a ratio of two different wavelengths of thermal radiation emitted by the article 104. Such ratio pyrometers allow for the temperature measurement of the article 104 without regards to any media, dust, or other contaminants within the propellant 109 that may inhibit accurate temperature measurements using other technologies. The system may incorporate an article-specific conformal preheating system that ensures uniform and controlled heating of the article 104. A specialized electric heating plate may be provided to accommodate flat articles 104, enabling consistent heating. Furthermore, the system features versatile connectivity options, allowing for the integration of custom test articles 104 and specialized configurations.

In any embodiment comprising a heater 106, a temperature threshold may be predetermined, such as to apply the requisite amount of heat to the propellant 109 via the heater 106 to reach the predetermined temperature. The applicator 102 may contain a temperature sensor 128 along the flow path of the propellant 109 to monitor the temperature of the propellant 109 at a predetermined interval such that a “closed-loop” feedback configuration may be achieved to vary the amount of energy provided to the heater 106 and thus reach the predetermined temperature. The temperature may be predetermined to be between 0 and 3000 degrees Celsius.

In embodiments where the propellant 109 initially starts as a liquid gas, the propellant 109 transitions from a liquid to a gaseous state after it is exposed to the heated environment proximate the heater 106 in the void 132. This phase change increases the pressure and volume of the propellant 109.

Importantly, the nozzle 134 portion of the applicator 102 contains a converging-diverging section. The converging-diverging section is positioned after the heater 106. After passing through the heater 106, the propellant, having undergone volumetric expansion as a result of the increase in temperature, enters the converging section of the nozzle 134. In this section, the cross-sectional area gradually decreases, leading to an increase in flow velocity. The converging section serves to further compress and accelerate the propellant 109 as it flows towards the narrowest point of the nozzle.

Subsequently, the propellant enters the throat of the nozzle 134, which is the narrowest part of the converging-diverging section. At this point, the propellant undergoes maximum compression in the applicator 102. As the propellant 109 exits the throat and enters the diverging section of the nozzle 134, the cross-sectional area gradually increases. This expansion allows for the propellant 109 to maintain a high exit velocity at ambient pressure.

The applicator 102 may also include an injection port 126 for introducing the media into the propellant 109 prior to the propellant 109 exiting the applicator 102. The media may be any form of particulate or granular material, such as sand, gravel, or powdered substances. In some embodiments, granular media like crushed stones or media such as aluminum oxide or garnet may be used.

The injection port 126 is positioned upstream of the exit of the nozzle 134. In some embodiments, the injection port 126 may be positioned proximate a venturi tube or a converging-diverging section of the nozzle 134. This placement allows for introduction of the media into the flow path without the use of a pressurized supply of the media. By locating the injection port 126 upstream of the nozzle 134 exit, the injected substance can mix with the propellant 109 prior to exiting the applicator 102 via the outlet.

Referring now to FIG. 1, the apparatus may contain a sensor 118 positioned proximate the outflow of propellant 109 and media from the applicator 102. The sensor 118 is a particle velocimeter, structured to detect particle density/mass loading of the combined media and propellant 109 stream. The sensor 118 may also detect the media size distribution of the media in the propellant 109, the media spray distribution at various cross sections, and media velocity. The output of the sensor 118 may be operatively coupled to the controller 116, such as to provide this information to the user for subsequent data collection or adjustment to parameters such as pressure or heat.

In some embodiments, the applicator 102 may be coupled to a mechanical manipulator 108 such that the applicator 102 may be positioned and maneuvered relative the article 104. In other embodiments, the retainer 105 or the article 104 may be coupled to the mechanical manipulator 108 for movement relative to the applicator 102, while the applicator 102 remains stationary during operation.

In some embodiments, the mechanical manipulator 108 may be an automatic or semi-automatic multi-axis manipulator. In other embodiments, the mechanical manipulator 108 may be a manual multi-axis manipulator.

In some embodiments, the mechanical manipulator 108 may be a multi-axis mechanical manipulator. In one embodiment, the mechanical manipulator is a six-axis robot comprising six different axes of motion: up and down (vertical), left and right (horizontal), forward and backward (longitudinal), pitch (rotation around the X-axis), yaw (rotation around the Y-axis), and roll (rotation around the Z-axis). The robotic manipulator 108 may be programmed using computer instructions to follow predefined paths such as to move the applicator 102 or article 104 and thereby evenly distribute the flow of the propellant 109 and media, or if programmed to do so, concentrate the flow of the propellant 109 and media in predetermined areas of the article 104.

In other embodiments, the mechanical manipulator 108 may have two or more axes of motion. Such mechanical manipulators 108 may be selected to reduce costs or complexities. By way of example and not limitation, the mechanical manipulator 108 may be a multi-axis robot, depending on the specific application requirements. A four-axis robot typically moves in three linear axes and one rotational axis, while a five-axis robot adds an additional rotational axis for enhanced maneuverability.

The apparatus may include an enclosure, such that one or more components of the apparatus are enclosed and contained within the enclosure to facilitate the transportation of the apparatus to various locations. For example, the apparatus may be contained within a shipping container, such as a standard metal ISO shipping container, which provides a secure environment for the apparatus during transit such that the apparatus remains undamaged while being transported to different locations. By utilizing a shipping container, the apparatus can be easily loaded onto trucks, trains, or ships, offering flexibility and integration into existing logistics systems. In other embodiments, various other fabricated enclosure systems are contemplated, such as crates, pallets, or other custom enclosure fabricated from suitable materials such as metal, plastic, or composite.

In some embodiments, the enclosure may comprise the applicator 102, the retainer 105, the mechanical manipulator 108, or any suitable combination thereof.

To facilitate the testing at high velocities, external to the container may be user interface 112 and computing device 120. The user interface 112 is structured to allow a user to interact with the apparatus, allowing a user to input commands, receive feedback, and access the functionalities provided by the computing device 120. The user interface 112 can take various forms, such as a graphical user interface (GUI).

The computing device 120 is computer hardware that executes computer instructions to execute processes related to the apparatus. For example, the computing device 120 may be a programmable logic controller (“PLC”) operatively coupled to the controller 116 to communicate commands, including, but not limited to, lowering or raising the temperature of the propellant 109, collect data from sensor 118, collect data from the temperature sensor 128, move the mechanical manipulator 108 relative to the article 104, and so forth.

In some embodiments, the apparatus may include an evacuation unit 114. The evacuation unit 114 is a vacuum collection device that may be structured with a vacuum port, nozzle, and a filter, to collect and remove media from the container, air, or areas proximate the article 104. Accordingly, the portions of the evacuation unit 114 that collect the media may be in fluid communication with the controller 116 to recycle the media collected by the evacuation unit and introduce the recycled media into the propellant 109 at the applicator 102.

Additionally, or alternatively, the apparatus may include an evacuation unit 114 structured for gas recovery. Such evacuation units 114 acts as a gas collection device, equipped with a gas inlet and gas outlet, which allow for the evacuation unit 114 to retrieve gases from the enclosure or regions surrounding the applicator 102. Portions of the evacuation unit 114 responsible for gas retrieval may be in fluid communication with the applicator 102 or conduit between the container 110 or the controller 116, and the applicator 102 allowing for the recycling of the collected gases. This recycled gas is then reintroduced into the propellant 109 at the applicator 102, serving to enhance operational efficiency.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for high velocity erosion testing of an article, the apparatus comprising:
a container;
a propellant stored in the container, wherein the propellant is stored under pressure in the container;
an applicator, the applicator being in fluid communication with the container, the applicator comprising a heater; and
a controller for controlling the heater and the flow of propellant from the applicator; and wherein the applicator is structured to discharge the propellant at a high velocity.

2. The apparatus of claim 1, wherein the applicator introduces media into the propellant.

3. The apparatus of claim 1, wherein the apparatus further comprises an enclosure comprising a retainer.

4. The apparatus of claim 1, wherein the apparatus further comprises an evacuation unit.

5. The apparatus of claim 3, wherein the enclosure comprises an evacuation unit to collect media introduced by the applicator into the propellant.

6. The apparatus of claim 1, wherein the applicator comprises a mechanical manipulator.

7. The apparatus of claim 1, wherein the propellant comprises a fluid selected from the group consisting of nitrogen, hydrogen, carbon dioxide, helium, and oxygen, and mixtures thereof.

8. The apparatus of claim 1, wherein the fluid, when stored under pressure in the container, is at least one selected from the group consisting of a liquid phase and a gaseous phase.

9. A method for high velocity erosion testing of an article in a testing device, the method comprising:
storing propellant in a container;
discharging the propellant from the container to an applicator;
heating the propellant;
discharging the propellant from the applicator at a controlled speed; and
exposing the article to high-velocity flow for a predetermined time period.

10. The method of claim 9 further comprising, prior to the second discharging step, introducing media into the propellant.

11. The method of claim 10, further comprising collecting media in an evacuation unit.

12. The method of claim 9, wherein the propellant comprises a fluid selected from the group consisting of nitrogen, hydrogen, carbon dioxide, helium, and oxygen, and mixtures thereof.

13. The method of claim 9, wherein the fluid, when stored under pressure in the container, is at least one selected from the group consisting of a liquid phase and a gaseous phase.

14. The method of claim 9, wherein the predetermined time period exceeds twenty minutes.
